(19) United States
(12) Patent Application Publication
(10) Pub. No.: US 2003/0065822 A1
(43) Pub. Date: Apr. 3, 2003

(54) Switch box appliance

(76) Inventor: Kenneth C. Avery, Houston, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 09/967,605

(22) Filed: Sep. 29, 2001

(51) Int. Cl. G06F 15/16

(52) U.S. Cl. 709/250; 709/251

(57) ABSTRACT

A switch box appliance is adapted for controlling a network of servers. The appliance includes a network interface controller (NIC), an input/output controller coupled to the NIC and an input/output driver. The input/output controller that is controlled by the input/output drivers sends commands through the NIC over an Internet protocol network, such as a Transmission Control Protocol/Internet Protocol (TCP/IP) network, to a server on the network.

### CROSS-REFERENCE TO RELATED APPLICATIONS

Not Applicable.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

This invention relates to computer networks, and more specifically to a switch box appliance for controlling a network of servers.

2. Description of the Related Art

Computer networking is a rapidly evolving technology typically requiring a network of servers to be managed from a console. These servers may be dispersed within a smaller geographic area or may be dispersed nationally or globally. Management of servers requires capabilities for operator input and response output from the servers. Typically, a mouse and a keyboard are used for providing operator input and a video display is used for displaying the response output. The mouse, the keyboard and the video display are generally referred to as the console.

Operation and management of a server typically requires communication links from a switch box to a server. A switch box allows use of one console to manage several servers. Each server has connections to a switch box to provide access to the console. The operator, through the switch box, selects a particular server for managing. Because a switch box has limited space to accommodate physical connections, typically four to eight computers can be connected to a single switch box. Typically, keyboard, mouse, and video connections are provided to each server. Thus, as the number of servers increases, the number of required physical connections grows. Accordingly, console management of a large number of servers, from a hardware viewpoint becomes costly, difficult to setup, and difficult to maintain.

One technique of connecting the servers to the console involves utilizing several switch boxes daisy chained together between switch boxes and servers. Switch boxes are appropriately switched to establish keyboard, mouse and video connection to the desired server. This technique requires repeated physical operations, and possibilities of errors increase substantially with the size of the network. Another technique involves utilizing Compaq Computer Corporation's Remote Insight Lights-Out Card for snooping the video memory on the server and transmitting the data using Hyper Text Transport Protocol (HTTP) to a web page interface. The Remote Insight Lights-Out Card is a Peripheral Component Interconnect (PCI) board that is installed in a server to provide remote server management capability. Using the card, one can access the console of the host server, including text mode and graphic mode screens with keyboard and mouse controls. This technique requires repeated transfer of large amounts of video data back and forth between the video display and the server. According to one estimate, approximately 4 MB of video data per frame is typically transferred between a server and a web page interface. Since a large number of servers are involved, this technique generates substantial data traffic over the web page interface. Consequently, a large amount of data bandwidth is used over the communication links that results in a substantial degradation of the system performance. Still another technique requires physically attaching a console to the front or back of the server that is to be managed. As the number of servers on networks keeps growing, the above techniques become more hardware intensive, difficult to maintain and service, and prone to errors.

### BRIEF SUMMARY OF THE INVENTION

A switch box appliance is adapted for controlling a network of servers. The appliance includes a network interface controller (NIC), an input/output (I/O) controller coupled to the NIC and an input/output driver. The input/output controller that is controlled by the input/output driver sends commands through the NIC over an Internet protocol network, such as a Transmission Control Protocol/Internet Protocol (TCP/IP) network, to a server on the network.

### BRIEF DESCRIPTION OF THE SEVERAL VIEWS OF THE DRAWINGS

A better understanding of the present invention can be obtained when the following detailed description of some embodiments is considered in conjunction with the following drawings in which:

FIG. 1 is a block diagram showing an exemplary relationship of a switch box appliance with servers, a video display, a keyboard, and a mouse.

FIG. 2 is a block diagram showing a server and the switch box appliance of FIG. 1.

FIG. 3 is a block diagram showing an embodiment of the switch box appliance of FIG. 1 with an application specific integrated circuit (ASIC) and an exemplary configuration for controlling a server with the switch box appliance.

FIG. 4 is a diagram depicting an exemplary relationship between the switch box appliance and server of FIG. 1.

FIG. 5 is a diagram depicting an exemplary relationship between the switch box appliance and a server of FIG. 1 utilizing software emulation.

FIG. 6 is flowchart of an exemplary technique of controlling servers on the network with the switch box appliance of FIG. 1.

### DETAILED DESCRIPTION OF THE INVENTION

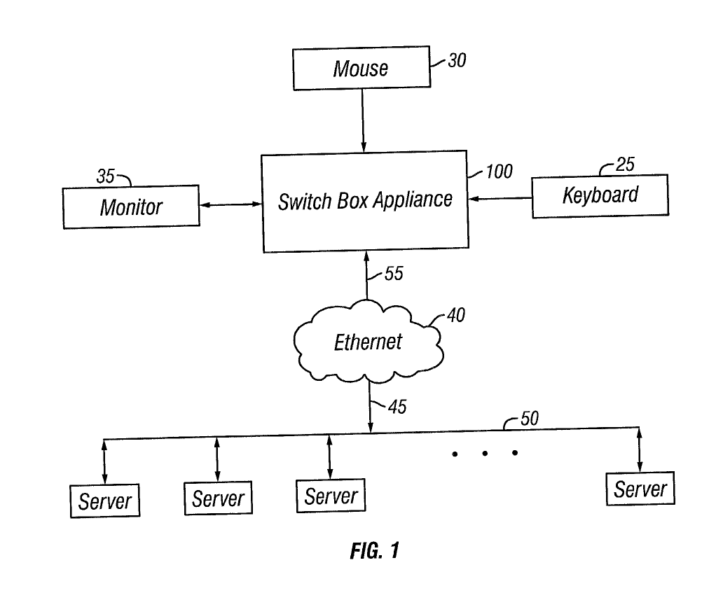

With reference to FIG. 1, an exemplary relationship 10 of a switch box appliance 100 with servers 50, a video display or monitor 35, a keyboard 25, and a mouse 30 is illustrated. The switch box appliance 100 is coupled to the keyboard 25 and the mouse 30 for console input data from an operator and the video display 35 is provided to display output responses from the appliance 100. The appliance 100 is coupled to the servers 50 through an Internet protocol (IP) network, such as a Transmission Control Protocol/Internet Protocol (TCP/IP) network, i.e., a network with the TCP/IP protocol. An example of the TCP/IP network is the Ethernet. Other transmission media, for example token ring, as would be apparent to those skilled in the art, may be used. The appliance 100 communicates by controller or console commands 45 to the servers 50 and receives responses 55 from the servers 50.

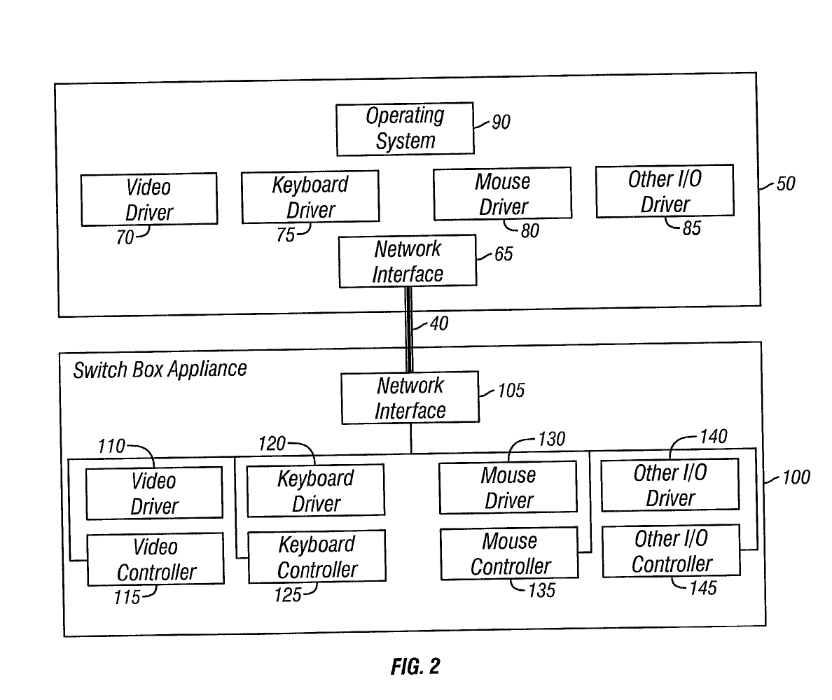

With reference to FIG. 2, an exemplary embodiment of the switch box appliance 100 and the server 50 is illustrated. The appliance 100 includes a video or graphics controller 115, a keyboard controller 125, a mouse controller 135, and/or other I/O controllers 145, for example, a printer controller, coupled or interfaced with a network interface controller (NIC) 105. The appliance 100 further includes a mouse connector, a keyboard connector, and a video connector for connecting the mouse 30, the keyboard 25, and the video display 35. Throughout this disclosure, the term “console” generally refers to the physical devices used for interfacing between a computer and a computer operator, including, but not limited, to a keyboard, a mouse, and a video display. The input/output controllers 115, 125, 135, and 145 are used to send commands through the appliance NIC 105 over the TCP/IP network 40 to the server 50. The input/output controllers 115, 125, 135, and 145 communicate with one server at a time. These controllers 115, 125, 135, and 145 act as console device controllers.

With this overall arrangement, the server 50 no longer includes input/output controllers, and thus the power that was previously used in the server 50 to power the input/output controllers is saved. As a consequence, the server 50 runs cooler and electronic board real estate in the server 50 is saved. The server 50 may include a video driver 70, a keyboard driver 75, a mouse driver 80, and/or other I/O drivers 85 coupled or interfaced with the server NIC 65. The server 50 further includes an operating system 90 which generally communicates and interfaces with the input/output drivers 70, 75, 80 and 85. The drivers 70, 75, 80 and 85 on the server 60 accept commands from the operating system 90. The video, mouse, and keyboard controller commands from the input/output controllers 115, 125, 135 and 145 are packetized in the switch box appliance 100 for transmission to the server 50. The appliance 100 can be co-located with the servers 50 or can be remotely located from the servers 50. With respect to the server network interface 65 and the appliance network interface 105, the switch box appliance 100 and the host server 50 may each utilize RJ-45 Ethernet connector.

By providing a console which may be owned or used by any server, the switch appliance 100 eliminates a need for a console for each server, and therefore any need for video, mouse and keyboard connections with the server, thus simplifying overall physical connections. The appliance 100 can be a handheld computer, a laptop computer, or a dedicated server. Thus, the term “appliance” is consistent with various types of computers. A single appliance 100 can support as many servers as there are IP addresses available on the network as opposed to previous limitations imposed by the availability of physical console connections to switch boxes. The switch box appliance 100 thus can easily support an entire rack or room of servers.

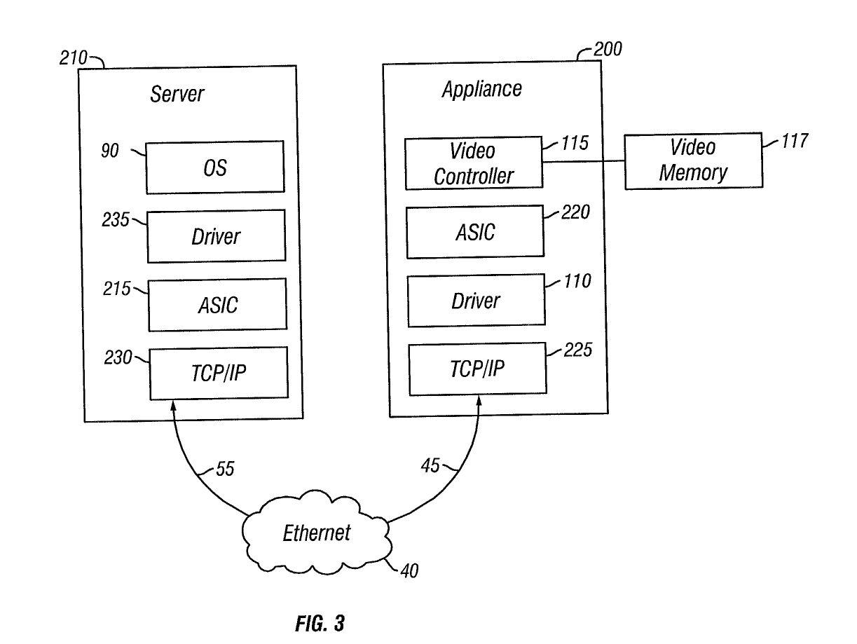

With reference to FIG. 3, an exemplary application specific integrated circuit (ASIC)-based embodiment of the appliance 200 and its communication with the server 210 is illustrated. The appliance 200 includes a video controller 115 coupled with an ASIC 220, a device driver 110, and a TCP/IP stack 225. The video controller 115 may provide sufficient functionality to minimize communication between the video driver 100 and the video display 35. The ASIC 220 processes video data from the driver 110 and places the data in the registers of the video controller 115. The ASIC 220 acts as an interface for the driver 110 and thus avoids the need for customizing the driver 110. A video memory 117 is coupled with the video controller 115 and may be implemented as random access memory (RAM) or flash read-only memory (ROM), for example. The server 210 includes an operating system 90 that is coupled to an ASIC 215 through a device driver 235. The appliance 200 is coupled to the server 210 through the Ethernet 40 over which commands 45 are communicated. The ASIC 215, which mirrors or matches the registers of the driver 235, gathers register data from the driver 235. A TCP/IP stack 230 receives the data and packetizes the data for transport over the Ethernet 40 to the appliance 200.

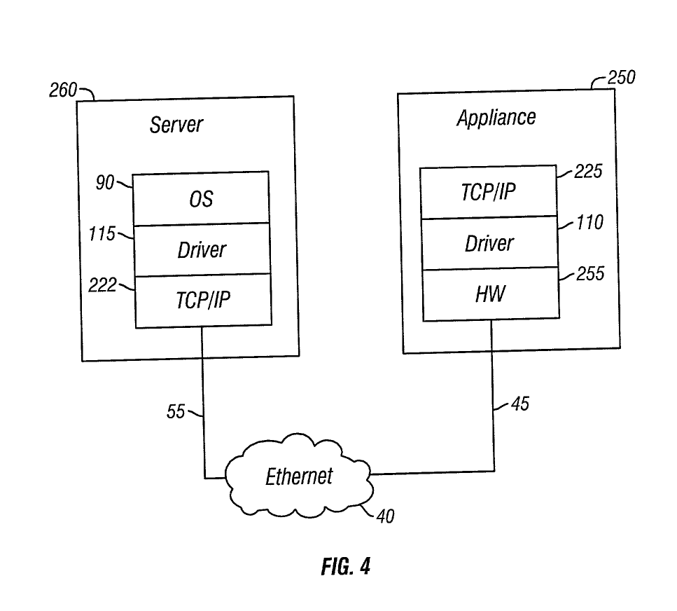

With reference to FIG. 4, a diagram depicting an exemplary relationship between a switchbox appliance 250 and a server 260 is shown. The appliance 250 includes a TCP/IP stack 225 interfaced to driver 110 that interfaces with console hardware 255. The console hardware 255 generally refers to the mouse controller 135, the keyboard controller 125, the video controller 115, and/or other I/O controller 145. The server 260 includes operating system 90, the driver 115, and the TCP/IP stack 222. Due to the console hardware 255 in the appliance 250, the server 260 does not require any of the hardware 255.

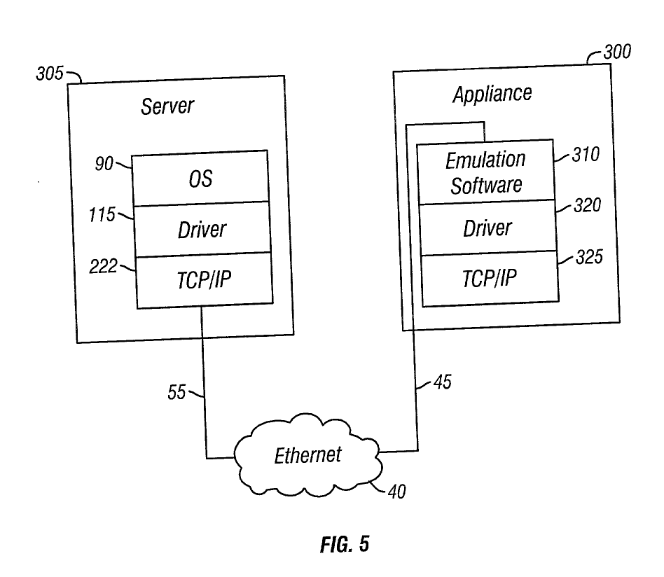

Referring to FIG. 5, an alternative embodiment of the switchbox appliance 300 is shown. The server 305 includes a device driver 115 interfaced to an operating system 90 and TCP/IP stack 222 interfaced to the operating system 90. The appliance 300 includes a driver 320 interfaced to TCP/IP stack 325 and to emulation software 310. The device driver 115 may packetize the console commands and send them over the Ethernet 40 to the emulation software 310. The emulation software 310 emulates controller commands sent from the appliance 300 to the server 305 using TCP/IP or some other transport protocol layer for reliable transfer of packets. This embodiment in FIG. 5 is similar to the one shown in FIG. 4 except that the remote console hardware 255 is replaced by emulation software 310. Other embodiments of the communication configurations between the appliance 100 and the servers 50 may be formed, for example, where the server 210 of FIG. 3 communicates with the appliance 250 (FIG. 4) or appliance 300 (FIG. 5) through the Ethernet 40. Likewise other such configurations would be apparent to those of skill in the art. It should be understood that video or other miscellaneous commands can be communicated between the appliance 300 and the server 305.

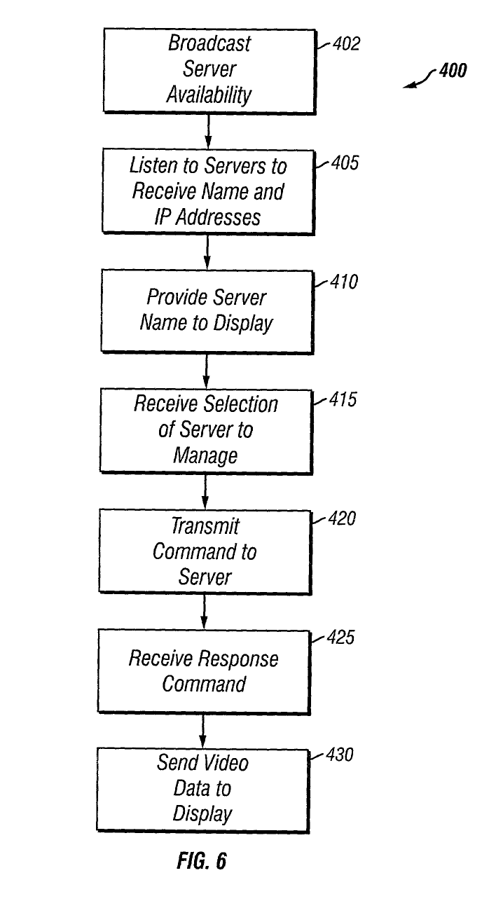

With reference to FIG. 6, a technique 400 of controlling a network of servers 50 with the switch box appliance 100 is illustrated. To determine a server's availability for control or management, the appliance 100 broadcasts a discovery request over the TCP/IP network 40. The servers 50 which are available for management respond with their names and/or IP addresses. In block 405, the appliance 100 listens to servers 50 to receive the names and/or IP addresses of the servers 50 available for control. In block 410, the appliance 100 provides names of the responding servers and/or their IP addresses to the video display 35. Next, in step 415, the appliance 100 receives a selection of a server to manage from the operator. In block 420, the appliance 100 transmits the command 45 to the selected server over the TCP/IP network 40. The commands to the server being controlled can be keyboard commands, mouse commands or video commands, for example. At this time, the selected server believes that the console of the switch box appliance 100 belongs to the selected server 50. The controller commands 45 are created by the controllers 115, 125, 135, and 145 in the appliance 100 based on input from the computer operator. Since only commands 45 are communicated over the TCP/IP network 40, communication bandwidth is conserved. The only data transmission is between the appliance 100 and the display 35. The server being controlled in turn replies with commands to the appliance 100 in step 425. In response to the command from the controlled server, the appliance 100 sends corresponding video data to the display 35 on the server 50 in step 430.

The foregoing disclosure and description of the preferred embodiment are illustrative and explanatory thereof, and various changes in the components, the switch box appliance configurations, the server configurations, and connections, as well as in the details of the illustrated circuitry and construction and techniques of operation may be made without departing from the spirit and scope of the invention.

What is claimed is:

1. A switch box appliance for controlling a network of servers, the appliance comprising:
a network interface controller (NIC);
an input/output controller coupled to the NIC; and
an input/output driver to control the input/output controller to send a command through the NIC over an Internet protocol network to a server of a plurality of servers coupled to the Internet protocol network.

2. The appliance as in claim 1, wherein the input/output controller comprises a video controller.

3. The appliance as in claim 2, further comprising:
a video memory coupled to the video controller.

4. The appliance as in claim 1, wherein the input/output controller comprises a mouse controller.

5. The appliance as in claim 1, wherein the input/output controller comprises a keyboard controller.

6. The appliance as in claim 1, wherein a plurality of input/output controllers is coupled to NIC to send commands over the Internet protocol network to the server.

7. The appliance as in claim 1, wherein the input/output controller is emulated in software.

8. The appliance as in claim 1, further comprising:
an Application Specific Integrated Circuit (ASIC) to interface between the input/output driver and the input/output controller.

9. The appliance as in claim 1, wherein the commands are broadcast over the Internet protocol network.

10. The appliance as in claim 1, wherein the Internet protocol network comprises a Transmission Control Protocol/Internet Protocol (TCP/IP) network.

11. A system for controlling a network of servers, the system comprising:
a switch box appliance, comprising:
a network interface controller (NIC);
an input/output controller coupled to the NIC;
an input/output driver to control the input/output controller to send a command through the NIC over an Internet protocol (IP) network; and
a server, comprising:
an operating system;
a server input/output driver interfaced with the operating system; and
a server NIC providing a Transmission Control Protocol/Internet Protocol (TCP/IP) stack interfaced with the server input/output driver to receive the command from the switch box appliance over the IP network.

12. The system as in claim 11, wherein the input/output controller comprises a video controller.

13. The system as in claim 12, the switchbox appliance further comprising:
a video memory coupled to the video controller.

14. The system as in claim 13, wherein the video memory is accessed in response to a reply from the server to the command.

15. The system as in claim 11, wherein a plurality of input/output controllers is coupled to the NIC to send commands over the IP network to the server.

16. The system as in claim 11, wherein the input/output controller is emulated in software.

17. The system as in claim 11, further comprising:
an Application Specific Integrated Circuit (ASIC) to interface between the input/output driver and the input/output controller.

18. The system as in claim 11, wherein the appliance comprises a dedicated server.

19. The system as in claim 11, wherein the appliance comprises a handheld computer.

20. The system as in claim 11, wherein the IP network comprises a wireless Ethernet network.

21. The system as in claim 11, wherein the IP network comprises a plurality of servers.

22. A method of controlling a network of servers, the method comprising the steps of:
transmitting a control command over an Internet protocol (IP) network to a server from a controller of a switchbox appliance;
receiving a response from the server; and
transmitting data from the switchbox appliance to a display device based on the response.

23. The method as in claim 22, further comprising the steps of:
transmitting an Internet protocol (IP) discovery packet to a plurality of servers on the IP network; and
receiving server availability responses from available servers on the IP network.

24. The method as in claim 22, the step of transmitting a control command comprising the step of:
transmitting the control command to a selected server.

25. The method as in claim 22, wherein the control command comprises a console command.
